(19) United States
(12) Patent Application Publication
(10) Pub. No.: US 2026/0121025 A1
(43) Pub. Date: Apr. 30, 2026

(54) RAPID CALCINATION AND CARBON COATING PROCESS FOR BATTERY ELECTRODE MATERIALS

(71) Applicant: UCHICAGO ARGONNE, LLC, Chicago, IL (US)

(72) Inventors: Ozgenur KAHVECIOGLU, Naperville, IL (US); Jianlin Li, Naperville, IL (US); Beihai Ma, Naperville, IL (US); Mateusz Zuba, Darien, IL (US)

(73) Assignee: UCHICAGO ARGONNE, LLC, Chicago, IL (US)

(21) Appl. No.: 19/343,774

(22) Filed: Sep. 29, 2025

Related U.S. Application Data
(60) Provisional application No. 63/714,302, filed on Oct. 31, 2024.

(51) Int. Cl. H01M 4/36; C01B 25/45; C01G 45/1228; H01M 4/58; H01M 4/587

(52) U.S. Cl. CPC H01M 4/366; C01B 25/45; C01G 45/1228; H01M 4/5825; H01M 4/587; C01P 2002/72; C01P 2004/03; C01P 2004/80; C01P 2006/40

(57) ABSTRACT

A method of preparing a carbon-coated electrode-active material comprises inductively heating a powdered mixture of an alkali metal source, a decomposable carbon source and precursors for the electrode-active material within an induction heating coil at two or more different induction frequencies. The mixture is induction-heated at a first frequency, then at a second frequency that is higher than the first frequency, and finally at a third frequency that is higher than the second frequency, to thereby form a carbon-coated electrode-active material.

### CROSS-REFERENCE TO RELATED APPLICATIONS

This application claims the benefit of U.S. Provisional Application Ser. No. 63/714,302 filed on Oct. 31, 2024, which is incorporated herein by reference in its entirety.

### CONTRACTUAL ORIGIN OF THE INVENTION

The United States Government has rights in this invention pursuant to Contract No. DE-AC02-06CH11357 between the United States Government and UChicago Argonne, LLC representing Argonne National Laboratory.

### FIELD OF THE INVENTION

This invention relates to methods for calcination and carbon coating of battery electrode-active materials.

### BACKGROUND OF THE INVENTION

Cathode active materials for rechargeable batteries (e.g., lithium ion and sodium ion batteries) are composed of earth-abundant materials, such as manganese (Mn) and iron (Fe). The cathode materials are utilized as powders that typically are coated onto a conductive current collector to form a cathode. Mn, Ni, and Co oxide composites, also known as NMC materials are commonly used as cathode materials. Lithium-rich and manganese-rich (LMR) layered NMCs, which are sometimes referred to as LMR-NMCs, are desirable cathode materials due to their reduced cobalt content. LMR-NMCs, in their pristine, as-formed state, exhibit low conductivity, and are typically mixed with an electrically conductive additive (such as carbonaceous materials) prior to electrode manufacturing.

Another Mn-based cathode material, primarily composed of Mn and titanium (Ti) is the lithium excess disordered rocksalt (DRX) composition. Poor electrical conductivity is much more severe in DRXs as compared to LMR-NMCs, and thus, DRX cathode powders typically are coated or mixed with high amounts of carbonaceous materials (up to 30 wt %).

Another class of earth abundant cathode chemistry are the alkali-metal transition-metal polyanion cathode materials (often referred to herein simply as polyanion cathode materials), such as lithium iron phosphate (LFP), which also have low conductivity and often suffer from sluggish diffusion of Li+ions, resulting in high polarization and lower specific capacity. Since their deployment in EV batteries, LFP powder materials have been coated with carbon and/or other carbonaceous materials to improve conductivity. LFP belongs to a group of cathode active materials of general chemical formula of LiMPO₄, which adopt the olivine crystal structure. M can be one or multiple of Fe, Co, Mn, Ti, V, and other transition metals. LFP is the first commercial LiMPO₄. Materials of formula LiMPO₄ in which M is a combination of Mn and Fe lithium also form an olivine structure. These materials are often referred to as LFMP materials and are a useful contributor to the cathode of lithium rechargeable batteries as the olivine structure is created when lithium is combined with manganese, iron, and phosphate (as described above). The olivine cathode materials demonstrate superior stability and safety with low cost.

All the powder materials discussed above are mixed with or surface-coated with a carbon material or are mixed with another electronically conducting agent to address the above-mentioned problems. In some cases, doping with other elements (e.g., Al, Ga, Ti, V, Cr, Si, Mg, B, Nb, Zr, W, F) may be also required to enhance conductivity or other electrochemical properties. The cathode active materials are prepared by mixing starting precursors comprising transition metal (TM)-containing materials with an alkaline source of lithium (for lithium battery application) or sodium (for sodium battery applications) through a high temperature calcination process. These processes typically involve multiple steps (preparation of precursor mixtures, calcination of the precursor mixture to form the cathode active material, and carbon-coating) using, for example, sol-gel techniques or ball milling; however, these systems are yield-limited and often not reliably reproducible. Hydrothermal processes have also been used; however, they are energy-intensive and also require an additional step of high temperature calcination.

Conductive agent coating/doping technologies include, e.g., vapor phase technologies such as chemical vapor deposition (CVD), atomic layer deposition (ALD), radio frequency (RF) magnetron sputtering, and wet coating methodologies (e.g., as coprecipitation, sol-gel, or hydrothermal). All these coating methods are followed by high temperature calcination. Solid state coating methods such as ball milling, or dry coating under high shear forces also have been utilized. Problems with those methodologies include long processing times, non-homogeneous coating, and use of hazardous chemicals. Such processes are also expensive and require additional heat treatments steps after the coating is applied.

In general, most, if not all electrode-active materials (cathode and anode) can benefit from including carbon along with the electrode-active component to enhance conductivity, including both anode and cathode active materials.

There is an ongoing need for alternative processes to prepare suitably conductive electrode-active materials for rechargeable battery applications. The methods described herein address this ongoing need.

### SUMMARY OF THE INVENTION

The processes described herein produce carbon-coated electrode-active materials, such as polyanion cathode materials and most other classes of cathode and anode active materials, utilizing induction heating to calcine precursor materials to form a lithium or sodium electrode-active material, homogenize lithium (or sodium) distribution into the calcined material, form a carbonaceous coating on particles of the resulting electrode-active material, and securing the carbonaceous coating on the particle surfaces. As used herein, the terms “carbon-coated” and “carbonaceous coating” refer to a coating around the electrode-active particles, which is substantially comprised of elemental carbon, but can include small amounts of other elements (e.g., less than 10 mol % other elements), or which are completely comprised of elemental carbon.

In some embodiments, the process is a continuous process in which successively different induction frequencies are used to accomplish calcination, carbon-coating, and the like, on precursor mixture moving along a conveyor system. For example, in one version, the process utilizes at least three induction heating zones utilizing different induction frequencies in each successive zone. Varied-frequency induction heating is more energy efficient compared to single frequency heating. The multiple frequency induction heating can be performed in any order of low (e.g., about 10 Hz to about 10 kHz), medium (e.g., 10 kHz to about 100 kHz) or high (e.g., 100 kHz to about 1.2 MHz) frequencies. In some embodiments, the induction heating is performed at increasingly higher induction frequencies.

Low frequency induction heating provides the deepest heat penetration into particles of the electrode-active precursor material. It is used to heat the precursor mixture in bulk, homogenously. The resulting heat dissipation is across the bulk of the sample. Low frequency induction is primarily useful for lithiation/calcination of the particles, where the powder mixture of lithium or sodium precursors (such as, e.g., lithium carbonate, lithium hydroxide, sodium carbonate, or sodium hydroxide, and hydrates thereof), transition metal-containing precursors (such as, e.g., TM phosphates, carbonates or hydroxides, and the like) and a carbon precursor (e.g., sucrose of other carbohydrates) is heated homogenously. When this bulk heating is applied, thermochemical reactions occur (thermal decomposition, water evaporation, etc.) and lithium or sodium diffuses inside the transition metal framework. This creates the lithiated (or sodiated) electrode-active material. The bulk heating calcines the mixture and provides lithium (or sodium) diffusion inside the TM structure. In addition, the carbonaceous material also starts to pyrolyze the carbon species.

Medium frequency induction heating provides additional heat penetration depth. Even though the thermal decomposition process is initiated through low frequency induction heating, lithium (or sodium) diffusion and placement into correct atomic positions requires additional heating. The medium frequency induction heating helps homogenize the lithium (or sodium) diffusion, and also generally completes carbon pyrolysis on the surface of the lithiated (or sodiated) TM electrode-active material.

High frequency induction heating provides the shallowest heat penetration depth. This means it only heats up the surface of the particles, where the electrically conductive carbon species are present. First, two induction heating steps-low and medium frequency create a lithiated (or sodiated) TM-containing electrode-active product with carbon on the surface of the particles. The final high frequency induction is only effective on the surface of the particles. So that when the powder mixture is moved from low and medium frequency induction stages to the high frequency induction stage, only carbon coating on the surface of the electrode particles will heat up. This helps to secure the carbon on the surface of the powder particles.

Induction heating furnaces provide a facile route towards calcining rechargeable battery cathode or anode precursor materials to reduce the manufacturing time, and therefore, the cost of synthesizing electrode-active materials such as, for example, anode materials (such as silicon-based materials (e.g., Si and SiOₓ), germanium-based materials (e.g., Ge and GeOₓ), lithium titanium oxide (Li₄Ti₅O₁₂), and transition metal carbides/nitrides (e.g., WC, TiₓC_{y}, Mn₃C, Co₃C)) and cathode materials (such as polyanion cathode materials (e.g., LFP and LMFP), metal oxide materials (e.g., NMC, LMR, or DRX materials), and conversion-type materials (e.g., FeFₓ and CuFₓ)). Induction heating utilizes a magnetic field to generate an electrical current in conductive materials and rapidly (almost instantaneously) converts the electrical energy into heat, and can reach a wide range of temperatures. Electronically conductive crucibles (e.g. nickel, graphite) can serve as a vessel to deliver rapid heat energy to the cathode/anode precursors when necessary.

The specific synthetic approach for making carbon-coated electrode-active materials, including anode materials and cathode materials described above, and most other classes of electrode materials, depends on several factors, including the choice of precursor chemistry, quality of precursors (fresh or recycled), rate-limiting reaction kinetics of the particular reactions involved, and appropriate induction heating parameters (e.g., induction frequency, dwell time within the induction coils and or each zone in a multizone induction furnace, and the like to achieve desired heating profiles).

The zoned induction heating processes described herein are useful for making essentially any carbon-coated cathode or anode electrode-active material. Such materials include, e.g., anode materials such as silicon-based materials (such as Si and SiOₓ), germanium-based materials (such as Ge and GeOₓ), lithium titanium oxide (Li₄Ti₅O₁₂), and transition metal carbides/nitrides (such as WC, TiₓC_{y}, Mn₃C, Co₃C), as well as cathode materials such as polyanion materials (such as LFP and LMFP), metal oxide materials (such as NMC, LMR, or DRX materials), conversion-type materials (such as FeFₓ and CuFₓ), and the like. The precursor materials for making these materials are well known to those of ordinary skill in the art, and are the same types of precursor materials used in conventional syntheses of these classes of materials. Typically, the precursor materials are initially heated at a relatively low frequency (e.g., about 10 Hz to about 10 kHz), followed by a medium frequency (e.g., about 10 kHz to about 100 kHz), and then a high frequency (e.g., about 100 kHz to about 1.2 MHz), which each heating zone being at a different, and progressively higher frequency.

In one embodiment, a process of preparing a carbon-coated cathode-active material comprises inductively heating a powdered precursor mixture of a transition metal-containing compound (e.g., iron phosphate, manganese oxide, or titanium oxide), an alkali metal source (e.g., a lithium or sodium hydroxide, carbonate, or bicarbonate), and a decomposable carbon source (e.g., a carbohydrate or a hydroxycarboxylic acid) within one or more induction heating coils operating at three or more different frequencies. For example, the precursor mixture is induction-heated at a first frequency (e.g., a low frequency of about 10 Hz to about 10 kHz) for a first period of time sufficient to at least partially calcine the powdered precursor mixture of the transition metal-containing compound and the alkali lithium or sodium source to form a lithium or sodium electrode-active material, respectively, and to at least initiate decomposition of the carbon source to carbon. Next, the calcined material is induction heated at a second frequency (e.g., a middle frequency of about 10 kHz to about 100 kHz) for a second period of time sufficient to complete the calcination and decomposition of the carbon source. Finally, the mixture is heated at a third induction frequency (e.g., a high frequency of about 100 kHz to about 1.2 MHz) for a third period of time sufficient to adhere the carbonaceous coating securely on the surface of the particles of the lithium or sodium electrode-active material. In some embodiments, the inductive heating at the first, second, and third frequencies is performed sequentially by passing the mixture through three different induction coils, one of which operates at the first frequency, the next of which operates at the second frequency, and the third of which operates at the third frequency.

The processes described herein provide a rapid and efficient method for preparing electrode-active materials with carbon coatings in a single solid-state process. This approach offers significant savings in cost and simplified materials handling. In addition, the process is flexible, where multiple induction heating zones can be included to achieve other process modifications, such as inducing crystal phase changes, homogenizing the carbon coating, and/or homogenizing distribution of doping elements. Additionally, cooling or quenching stages can be added between or after the induction heating stages, if desired, to stabilize a crystal structure or coating.

The following non-limiting embodiments are set forth below to highlight certain features and aspects of the membranes described herein.

Embodiment 1 is a process for preparing a carbon-coated electrode-active material comprising: inductively heating a precursor mixture of suitable metal-containing compounds, an alkali metal source, and a thermally decomposable carbon source at an induction frequency (e.g., about 10 Hz to about 1.2 MHz) sufficient to bring the precursor mixture to a temperature (e.g., about 600 to 850° C.) sufficient to thereby form the carbon-coated electrode-active material. The ratio of metal-containing compounds to the alkali metal source in the mixture is selected so that the final electrode-active material produced by the induction heating has a predetermined composition of metal ions, e.g., the composition of a particular target electrode-active material, such as a particular lithium or sodium iron phosphate material (e.g., LiMPO₄, where M comprises iron or a combination of iron with one of more other metal, such as Mn). In some versions of embodiment 1, the precursor mixture is heated at three different induction frequencies, e.g., wherein the mixture is sequentially inductively heated at a first frequency, a second frequency higher than the first frequency, and a third frequency higher than the second frequency, to thereby form the carbon-coated electrode-active material.

Embodiment 2 is the process of embodiment 1, wherein the first frequency is in the range of about 10 Hz to about 10 kHz; the second frequency is in the range of about 10 kHz to about 100 kHz; and the third frequency is in the range of about 100 kHz to about 1.2 MHz.

Embodiment 3 is the process of embodiment 1 or embodiment 2, wherein the electrode-active material is selected from the group consisting of a polyanion electrode-active material, a metal oxide electrode-active material, a conversion-type electrode-active material, and an anode electrode-active material.

Embodiment 4 is a process for preparing a carbon-coated alkali metal electrode-active material comprising: sequentially inductively heating a powdered mixture of a metal compound, an alkaline alkali metal source (e.g., an alkali metal salt), and a thermally decomposable carbon source in a suitable reaction vessel under an inert atmosphere at three different induction frequencies; wherein the mixture is inductively heated at a first frequency of about 10 Hz to about 10 kHz, e.g., to calcine the metal compound and the alkali metal source to form an alkali metal electrode-active material, induce migration of the alkali metal into the powder particles, and initiate decomposition of the carbon source; and is inductively heated at a second frequency of about 10 kHz to 100 kHz, e.g., to complete the calcination and homogeneous distribution of the alkali metal into the powder particles, and complete the decomposition the carbon source, thereby forming a carbonaceous coating around the particles of the resulting alkali metal electrode-active material; and is inductively heated at a third frequency of about 100 kHz to about 1.2 MHz, e.g., to secure the carbon coating to the surface of the particles. The metal compound can be a single compound or a mixture of compounds (e.g., a simple physical mixture or an intimate mixture formed by, e.g., coprecipitation),

Embodiment 5 is the process of embodiment 4, wherein the reaction vessel is an electrically conducting reaction vessel (e.g., Ni or graphite).

Embodiment 6 is the process of embodiment 4 or embodiment 5, wherein the induction heating is achieved by inductively heating the reaction vessel containing the mixture of the metal compound, the alkali metal source, and the thermally decomposable carbon source sequentially within at least three induction heating coils under an inert atmosphere; wherein the reaction vessel is inductively heated within:
(a) a first induction heating coil operating at the first frequency,
(b) a second induction heating coil operating at the second frequency, and
(c) a third induction heating coil operating at the third frequency.

Embodiment 7 is the process of embodiment 6, wherein the mixture is positioned within multiple electrically conductive reaction vessels situated on a moving conveyor belt that passes through the induction heating coils under an inert atmosphere, such that each container passes sequentially through each induction heating coil operating at a selected induction frequency, and the linear velocity at which the conveyor moves provides a residence time within the each induction coil sufficient to form the carbon-coated alkali metal electrode-active material.

Embodiment 8 is the process of any one of embodiments 1 to 7, wherein the decomposable carbon source is selected from the group consisting of a carbohydrate (e.g. sucrose, glucose, lactose, fructose, and the like), a hydroxycarboxylic acid (e.g. citric acid, tartaric acid, ascorbic acid, lactic acid, maleic acid, and the like), biomass (e.g. cellulose, lignin-based polymers, lignan, Sericin, vegetable oil, and the like), an organic polymer (e.g., polyacrylonitrile a phenol resin, a polyether such as polyethylene glycol or polypropylene glycol, and the like), and a petroleum product (e.g., asphalt, petroleum coke, and the like).

Embodiment 9 is the process of any one of embodiments 4 to 8, wherein the alkali metal is lithium (e.g., from lithium hydroxide, lithium nitrate, and lithium carbonate).

Embodiment 10 is the process of any one of embodiments 4 to 8, wherein the alkali metal is sodium (e.g., from sodium hydroxide, sodium nitrate, and sodium carbonate).

Embodiment 11 is the process of any one of embodiments 4 to 10, wherein the metal compound is selected from the group consisting of a metal oxide, a metal sulfide, a metal fluoride, a metal chloride, a metal phosphate, a metal pyrophosphate, a metal fluorophosphate, a metal sulfate, a metal fluorosulfate, a metal silicate, a metal carbonate, a metal borate, and a combination of two or more thereof.

Embodiment 12 is the process of any one of embodiments 4 to 11, wherein the metal of the metal compound is selected from the group consisting of Al, Cr, Ga, Mg, Nb, Sn, La, Ta, Ti, W, Y, Zr, Mo, Fe, Mn, Ni, Co, and a combination of two or more thereof.

Embodiment 13 is the process of any one of embodiments 4 to 12, wherein the alkali metal electrode-active material is a material of a formula selected from the group consisting of AMO; AMOX, AMO₂, AMO₂X, AMS₂, AMS₂X, AMX₂, AMX₃ AMPO₄, AMP₂O₇, AMPO₄F, A₂M(SO₄)₂, AMSO₄F, A₂MSiO₄, and AMBO₃; wherein A is Li or Na; and M is at least one element selected from the group consisting of Al, Ca, Co, Cr, Fe, Ga, La, Mo, Mg, Mn, Nb, Ni, Sn, Ta, Ti, V, W, Y, and Zr; and X is at least one element selected from the group consisting of F and Cl.

Embodiment 14 is a process for preparing a carbon-coated alkali metal iron phosphate electrode-active material comprising: inductively heating a mixture of an iron phosphate compound, an alkali metal source, and a thermally decomposable carbon source in a carbonaceous reaction vessel under an inert atmosphere at an induction frequency sufficient to raise to temperature of the precursor mixture to a temperature (e.g., about 600 to about 850° C.) sufficient to form the carbon-coated alkali metal iron phosphate electrode active material. In some versions of embodiment 14, the precursor mixture is inductively heated at three or more different induction frequencies; e.g., wherein the mixture is inductively heated at a first frequency of about 10 Hz to about 10 kHz; at a second frequency in the range of about 10 kHz to about 100 kHz; and at a third frequency of about 100 kHz to about 1.2 MHz; and wherein the alkali metal is Li or Na. The iron phosphate compound can be a single compound or a mixture of compounds.

Embodiment 15 is the process of embodiment 14, wherein the iron phosphate compound comprises at least one transition metal selected from the group consisting of Co, Cr, La, Mn, Mo, Nb, Ni, Sn, Ta, Ti, W, Y, and Zr, in addition to the iron.

Embodiment 16 is the process of any one of embodiments 14 to 16, wherein the alkali metal iron phosphate electrode-active material is a material of formula LiMPO₄; wherein M comprises Fe and optionally comprises at least one element selected from the group consisting of Al, Ca, Co, Cr, Ga, La, Mo, Mg, Mn, Nb, Ni, Sn, Ta, Ti, V, W, Y, and Zr.

Embodiment 17 is the process of embodiment 16, wherein the M is Fe or a combination of Fe and Mn.

Embodiment 18 is the process of any one of embodiments 14 to 17, wherein the induction heating is achieved by inductively heating the reaction vessel containing the mixture of the iron phosphate compound, the alkali metal source, and the thermally decomposable carbon source within at least three induction heating coils under an inert atmosphere; wherein the reaction vessel is inductively heated within:
(a) a first induction heating coil operating at the first frequency;
(b) a second induction heating coil operating at the second frequency; and
(c) a third induction heating coil operating at the third frequency.

Embodiment 19 is the process of embodiment 18, wherein the mixture is positioned within multiple electrically conducting reaction vessels situated on a moving conveyor belt that passes through the induction heating coils under an inert atmosphere, such that each container passes sequentially through each induction heating coil operating at a selected induction frequency, and the linear velocity at which the conveyor moves provides a residence time within each induction coil sufficient to form the carbon-coated alkali metal iron phosphate electrode-active material.

Embodiment 20 is the process of any one of embodiments 14 to 19, wherein the decomposable carbon source is selected from the group consisting of a carbohydrate (e.g. sucrose, glucose, lactose, fructose), a hydroxycarboxylic acid (e.g. citric acid, tartaric acid, ascorbic acid, lactic acid, maleic acid), biomass (e.g. cellulose, lignin-based polymers, lignan, Sericin, vegetable oil, and the like), an organic polymer (e.g., polyacrylonitrile a phenol resin, a polyether such as polyethylene glycol or polypropylene glycol, and the like), and a petroleum product (e.g., asphalt, petroleum coke, and the like).

Embodiment 21 is the process of any one of embodiments 1 to 20, wherein the carbon-coated electrode-active material is inductively heated at one or more additional induction frequency, e.g., to refine the structure thereof.

Embodiment 22 is the process of any one of embodiments 1 to 21, wherein the initially formed electrode-active material or the carbon-coated electrode-active material is rapidly cooled after being formed, to stabilize the crystal structure thereof.

Embodiment 23 is the process of any one of embodiments 13, 16, or 17, wherein the electrode-active material is doped with 0.1 to 20 mol % and/or is substituted with 20 to 90 mol % of one or more other element selected from the group consisting of Al, Ca, Co, Cr, Fe, Ga, La, Mo, Mg, Mn, Nb, Ni, Sn, Ta, Ti, V, W, Y, and Zr.

### BRIEF DESCRIPTION OF THE DRAWINGS

The accompanying drawings illustrate certain features and aspects of the methods, apparatus and systems described herein and are not meant to be limiting.

FIG. 1 provides a schematic illustration of a three-zone continuous induction heating system for use in implementing an embodiment of the methods described herein.

FIG. 2 provides (a, c) SEM and (b, d) XRD of iron (III) phosphate dihydrate (FePO₄⋅2H₂O) and lithium carbonate (Li₂CO₃) precursors used to prepare materials designated as Sample #1 and Sample #2.

FIG. 3 provides x-ray diffraction patterns of (a) Sample #1 and (b) Sample #2 with corresponding (c) phase composition.

FIG. 4 provides x-ray diffraction patterns of (a) Sample #3; and (b) Sample #4; and electrochemical cycling data for (c) Sample #3; (d) Sample #4; and (e) variable C-rate data (at C-rates shown) for Sample #3.

### DETAILED DESCRIPTION OF THE PRESENT INVENTION

Induction heating is a fast, efficient, precise, and repeatable non-contact method which generates heat on the surface of or within conductive materials due to interaction with electromagnetic wave penetration. In operation, a conductive workpiece is placed within an induction coil. Alternating current flowing in the coil induces eddy currents in the workpiece, causing it to become heated. The depth to which the eddy currents penetrate, and therefore the distribution of heat within the object, depends on the frequency of the primary alternating current and the magnetic permeability of the material, as well as the resistivity of the material. At lower frequencies, an eddy current is generated deep inside the conductive material. Conversely, at higher frequencies, an electromagnetic wave penetrates to a very shallow depth near the surface and generates intense heat only at the very surface layer or interface of the materials. Induction heating offers a cost-effective alternative to common calcination and coating processes by reducing the calcination and coating times from hours/days to minutes.

Described herein is a process for producing carbon-coated electrode-active materials for lithium ion and sodium ion batteries. In the methods described herein, inductive heat is selectively applied to intermixed precursor materials comprising a thermally decomposable carbon source and suitable starting materials for synthesizing a target electrode-active material. In the case of polyanion-type electrode-active materials, the precursor mixture typically includes a metal polyanion salt (e.g., phosphate, pyrophosphate, sulfate, silicate, or borate salts) and an alkali metal source, such as an alkali metal salt (e.g., Li or Na salts such as lithium carbonate or sodium carbonate), as well as a thermally decomposable carbon source mixed with the precursor materials. The induction frequency or frequencies are selected and controlled such that the precursor mixture is heated to a temperature sufficient to calcine the precursor mixture and form a lithium or sodium transition metal electrode-active material, and to decompose the carbon source to form a carbonaceous coating around particles of the electrode-active material.

Relatively low frequency (long wavelength) electromagnetic radiation (e.g., a frequency of about 10 Hz to 10 kHz) penetrates deep into precursor mixture particle causing rapid heating of the cathode precursor mixture to temperatures in excess of 500° C. (e.g., 500 to 900° C.), resulting in calcination of the mixture to form a lithiated (or sodiated, if an alkali sodium source is utilized in the precursor mixture) cathode active material. A relatively high induction frequency (e.g., a frequency of about 100 kHz to about 1.2 MHz) selectively heats a decomposable carbon source, such as a carbohydrate (e.g., a sugar such as sucrose, glucose, fructose, and the like, or a polysaccharide such as a starch), a hydroxy carboxylic acid (e.g., citric acid, glycolic acid, tartaric acid, and the like), biomass (e.g., lignan, Sericin, vegetable oil, and the like), polyethers (e.g., polyethylene glycol, polypropylene glycol, and the like), petroleum products (e.g., asphalt, petroleum coke, and the like). The process is carried out in an inert atmosphere to avoid oxidation of the carbon source. As the carbon source heats to high temperature (e.g., 400 to 600° C.), the material decomposes (e.g., by loss of water in the case of carbohydrates) to form a carbonaceous coating around the cathode active material.

Mid-range induction frequencies (e.g., a frequency of about 10 kHz to about 100 kHz) can be applied to complete calcination and carbon-coating formation, and to induce migration of lithium or sodium into the interior of the resulting cathode materials to homogenize the cathode active material. A yet higher induction frequency (e.g., 100 kHz to 1.2 MHz) heats just the surface of the carbon-coated particles to aid in securing the carbon coating to the particle surfaces. In practice, the induction frequencies used for the various process steps will depend for example, on the particular materials being heated, the particle size of the materials, the temperatures needed for the particular calcination and carbon forming steps, which will vary depending on the particular component materials utilized, and the relative amounts of the components of the initial mixture, among others.

Polyanion materials amenable to preparation by the process described herein include alkali metal phosphates, alkali metal pyrophosphates, alkali metal fluorophosphates, alkali metal sulfates, alkali metal fluorosulfates; alkali metal silicates; alkali metal borates, and the like. Non-limiting examples of alkali metal polyanion cathode materials that can be prepared by the processes described herein include, materials of the formulae AMPO₄; AMP₂O₇, AMPO₄F, A₂M(SO₄)₂, AMSO₄F, A₂MSiO₄, and AMBO₃; wherein A is Li or Na; and M is at least one transition metal selected from the group consisting of Al, Ca, Co, Cr, Fe, Ga, La, Mo, Mg, Mn, Nb, Ni, Sn, Ta, Ti, V, W, Y, and Zr.

Precursors for forming alkali metal transition metal electrode-active materials comprise metal compounds combined with an alkali metal source in a stoichiometry calculated to provide the empirical formula of a target electrode-active material, e.g., of one of the formulae described above, as is well known in the alkali metal battery arts. Non-limiting examples of transition alkali metal electrode-active materials include transition metal phosphates (e.g., LiFePO₄, LiMnPO₄, LiNiPO₄, LiCoPO₄, LiFe_{0.5}Mn_{0.5}PO₄), transition metal pyrophosphates (e.g., Li₂FeP₂O₇, Li₂MnP₂O₇, Li₂CoP₂O₇), transition metal fluorophosphates (LiVPO₄F, NaVPO₄F, Na₃V₂(PO₄)₂F₃, Li(Na)₂FePO₄F), transition metal sulfates (Li₂Fe(SO₄)₂, Li₂Co(SO₄)₂, Li₂Mn(SO₄)₂), transition metal fluorosulfates (e.g., LiFeSO₄F, LiMnSO₄F), transition metal silicates (Li₂FeSiO₄, Li₂MnSiO₄, Li₂CoSiO₄), and transition metal borates (LiFeBO₃, LiCoBO₃, LiMnBO₃). The transition metals can be, e.g., Co, Cr, Fe, La, Mo, Mn, Nb, Ni, Sn, Ta, Ti, V, W, Y, and Zr. Non-limiting examples of alkali metal source include, e.g., lithium carbonate, lithium hydroxide, lithium nitrate, lithium phosphate, lithium dihydrogen phosphate, sodium carbonate, sodium nitrate, sodium bicarbonate, sodium hydroxide.

The processes described herein can be applied to any type of carbon-coated electrode-active material (including cathode and anode materials), such as silicon-based materials (such as Si and SiOₓ), germanium-based materials (such as Ge and GeOₓ wherein x≤2), lithium titanium oxide (Li₄Ti₅O₁₂), transition metal carbides/nitrides (such as WC, TiₓC_{y} wherein x is 1 to 8, and y is 0.5 to 5, Mn₃C, Co₃C), polyanion materials (such as LFP and LMFP), metal oxide materials (such as NMC, LMR, or DRX materials), and conversion-type materials (such as FeFₓ and CuFₓ wherein x is 1 to 3). Precursor materials for preparing these and other types of electrode-active materials are well known in the battery arts.

Optionally, the polyanion cathode materials or other electrode-active materials can be doped (e.g., 0.1 to 20 mol % of the other elements) and/or substituted (e.g., 20 to 90 mol % of the other elements) with one or more other elements such as Al, Ca, Co, Cr, Ga, La, Mo, Mg, Mn, Nb, Ni, Sn, Ta, Ti, V, W, Y, and Zr. Doping/substitution can enhance stability, electrochemical properties, conductivity, and the like.

The decomposable carbon source for forming the carbonaceous coating can be any organic material that will thermally decompose to form elemental carbon under an inert atmosphere (e.g., argon gas, vacuum, etc.). Non-limiting examples of carbon sources include carbohydrates such as sucrose, mannose, starch, and the like, hydroxy carboxylic acids such as citric acid, malic acid, tartaric acid, and the like, biomass such as lignin, carbohydrate (e.g., a sugar such as sucrose, glucose, fructose, and the like, or a polysaccharide such as a starch), a hydroxy carboxylic acid (e.g., citric acid, glycolic acid, tartaric acid, and the like), biomass (e.g., cellulose, lignin-based polymers, lignan, Sericin, vegetable oil, and the like), polyethers (e.g., polyethylene glycol, polypropylene glycol, and the like), organic polymer (e.g., polyacrylonitrile a phenol resin, a polyether such as polyethylene glycol or polypropylene glycol, and the like), and petroleum products (e.g., asphalt, petroleum coke, and the like).

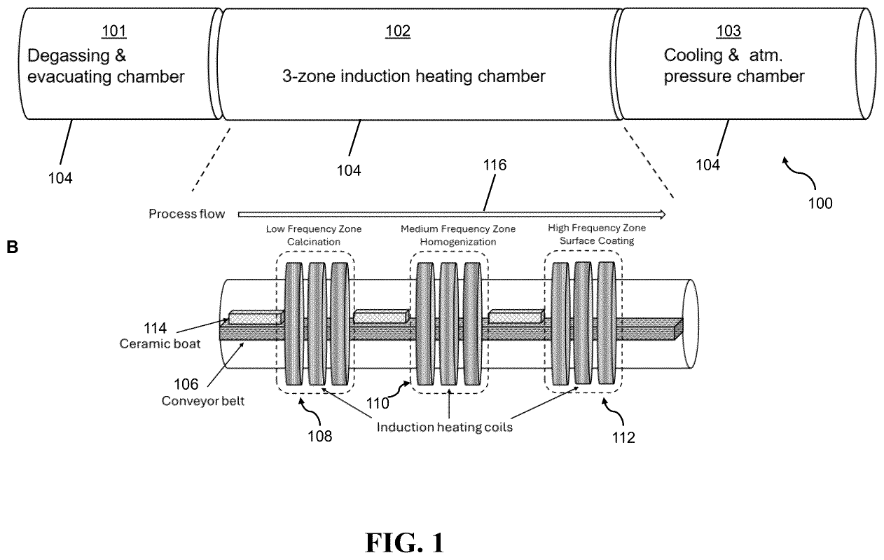

Referring now to the drawings, FIG. 1 provides a schematic illustration of a system for implementing the processes described herein. Panel A illustrates an embodiment with three distinct chambers, i.e., a 3-zone induction heating chamber 102 in communication with degassing and evacuating chamber 101 at one end thereof (e.g., to afford an inert atmosphere within the system), and cooling and atmospheric pressure chamber 103 at the other end thereof (e.g., to cool off products of the process and bring the material into a normal atmosphere. Each of chambers 101, 102 and 103 are defined by housing 104. Panel B illustrates the interior of chamber 102, which includes conveyor belt 106 running sequentially through three induction coils 108, 110, and 112, respectively. Carbonaceous reaction vessels 114 are situated on conveyor belt 106 and move with the belt in the direction of arrow 116 so that each vessel 114 will pass sequentially through coil 108, coil 110, and coil 112 when the system is operating. It is to be understood that additional induction heating coils can be included in the system to optimize the various process steps or add additional process steps such as homogenization of the carbon coating. Additionally, one or more of the coils can be a variable frequency induction coil, to allow flexibility to tune into a particular or optimum frequency for each coil. In an alternative embodiment, a single variable frequency induction furnace can be used and the frequency can be varied from low to high to achieve all of the induction heating steps without using separate coils.

In use, vessels 114 contain a mixture of decomposable carbon source (e.g., a carbohydrate), combined with precursors of an alkali metal transition metal electrode-active material, e.g., a mixture of a transition metal polyanion compound (e.g., a phosphate, fluorophosphate, pyrophosphate, sulfate, fluorosulfate, a silicate, or a borate) combined with an alkaline alkali metal source (e.g., LiOH, Li₂CO₃, LiHCO₃, and the like). Induction coil 108 operates at a relatively low frequency to heat the contents of the vessel to a temperature sufficient to calcine the precursor mixture to form the alkali metal transition metal electrode-active material. Coil 112 operates at a relatively high frequency relative to coil 108, to heat the decomposable carbon source to a temperature sufficient to convert the carbon source to primarily elemental carbon. Coil 110, situated between coil 108 and coil 112, operates at a frequency between the frequency of coil 108 and the frequency of coil 112, to heat the calcined precursor material to a temperature sufficient to at least partially homogenize the distribution of alkali metal ions within particles of the alkali metal electrode-active material. The linear extent and volume of the coils 108, 110, and 112, along with the linear speed of conveyor belt 106 are selected to provide a residence time for each vessel 114 in each of coils 108, 110, and 112 to afford a desired level of calcination, homogenization, and carbon coating formation in each vessel.

Optionally, one or more additional induction coils or zones can be included in the system.

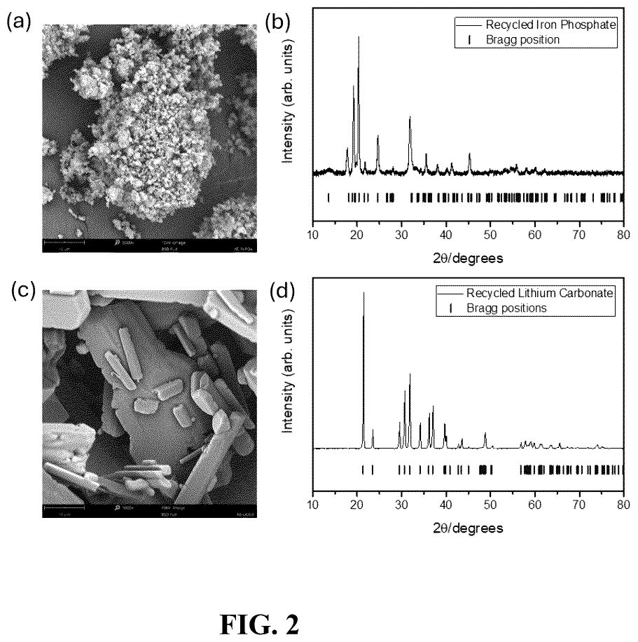

FIG. 2 shows (a, c) SEM and (b, d) XRD of iron (III) phosphate dihydrate (FePO₄*2H₂O) and lithium carbonate (Li₂CO₃) precursors used to prepare Sample #1 and Sample #2. SEM and diffraction of recycled feedstock materials confirm the phase and quality of the starting materials used for preparing Sample #1 and #2.

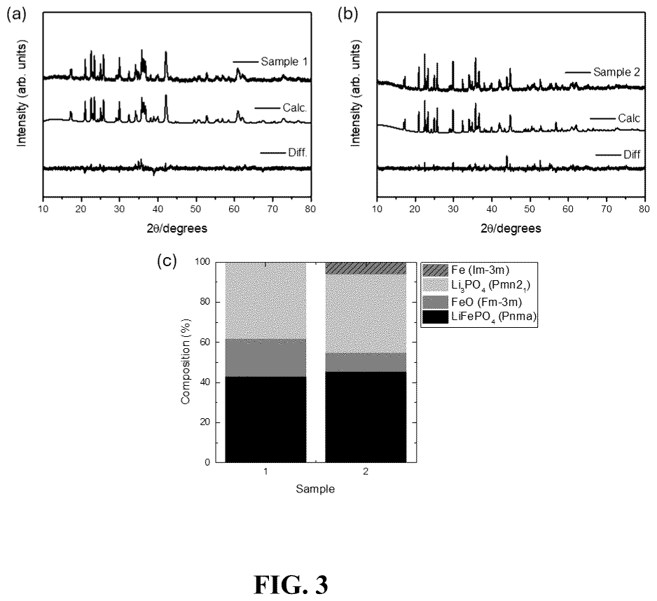

FIG. 3 shows x-ray diffraction patterns of (a) Sample #1 and (b) Sample #2 prepared using HFIH to achieve a temperature of 850° C. for 4 hours under an Ar atmosphere. Sample #1 was prepared in the absence of sucrose whereas Sample #2 was prepared with 1 wt % sucrose. Both Sample #1 and #2 were prepared with high Li₂CO₃ loadings resulting in pronounced Li₃PO₄ and FeO phase formation as shown in FIG. 3, Panel (c). In the case of Sample #2, Fe was observed in addition to Li₃PO₄ and FeO side products, whereas no Fe was observed in Sample #1. The presence of reduced Fe in the resulting products from trivalent iron phosphate precursors highlights the rapid carbothermal reaction occurring during the HFIH step. Excess Fe reduction was observed in the sample with the sucrose containing precursor mixture. This highlights the need for a low frequency (bulk heating) step to prevent/minimize overreduction of iron precursors. In both samples, however, more than 40% of the final product was the conversion to LFP.

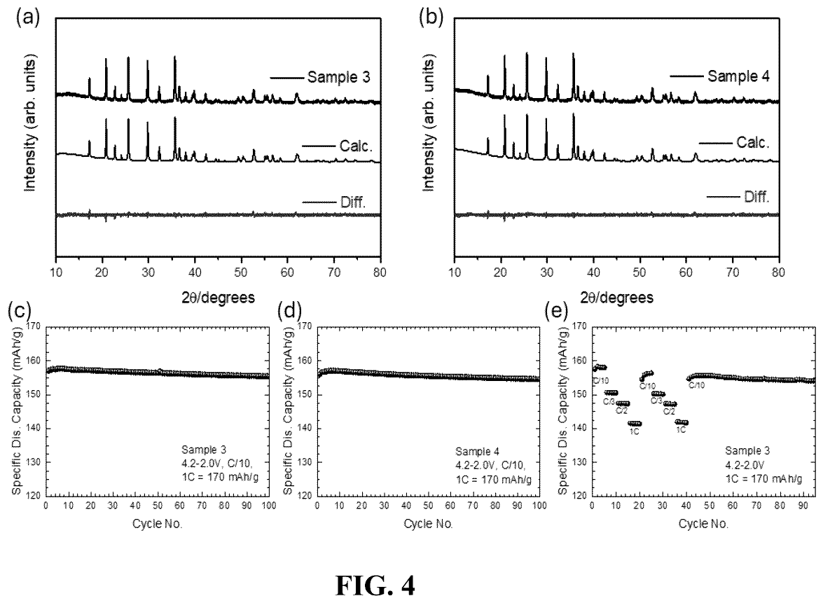

FIG. 4 shows x-ray diffraction patterns of (a) Sample #3 and (b) Sample #4, which are pure carbon-coated LiFePO4 prepared using HFIH for 1 hour under an Ar atmosphere. In sample preparation, a precursor mixture containing a molar ratio 1:1 of FePO₄⋅H₂O: Li₂CO₃ with 15 percent by weight (wt %) sucrose as the carbon source was obtained via planetary ball-milling. Sample #3 and Sample #4 were obtained through HFIH treatment at 600° C. and 700° C., respectively. Validation of the carbon-coated LiFePO₄ samples was carried out through electrochemical half-cell testing, where electrodes were prepared with a wt % ratio of 75:15:10 (Sample: Carbon: Binder). Electrochemical cycling of Sample #3, shown in FIG. 4, Panel (c), and of Sample #4, shown in FIG. 4, Panel (d), under constant current, exhibited high deliverable discharge capacities, whereas rate capability testing of Sample #3, shown in FIG. 4, Panel (e), afforded good discharge capacities at higher C-rates. Compared to classical calcinations, which utilize convection heating that typically requires long-temperature holds (≥12 hours) for complete synthesis, the HFIH-based approach described herein can generate a high-performing carbon-coated LiFePO₄ within a 1-hour calcination period. This highlights an improved rapid calcination and carbon-coated process through HFIH for generating lithium-ion battery electrode materials resulting in similar electrochemical performance metrics to established processes.

### EXAMPLE 1

### Preparation of Carbon-coated LiFePO₄

Stoichiometric amounts of Li₂CO₃ and FePO₄·2H₂O powders from recycled feedstock, with sucrose as a carbon source, are mixed using mortar and pestle or acoustic mixer, or planetary ball mill. The mixed powder is then placed in a graphite boat and placed in the center of an induction coil. Before the calcination, the chamber is evacuated twice.

The synthesis is conducted under flowing Argon at temperatures ranging from 600 to 850° C. at a high induction frequency, as described herein, to prepare a carbon-coated LiFePO₄ as described herein. In some embodiments, the material can be prepared at three different induction frequencies (low, medium and high) to prepare a carbon-coated LiFePO₄ as described herein.

### EXAMPLE 2

### Preparation of an Exemplary Mn-based Disordered Rock-salt (DRX) Cathode Materials

An aqueous 0.5 M Mn_{0.5}Ti_{0.5}SO₄ transition metal solution is prepared using equivalent molar amounts of MnSO₄⋅6H₂O and TiOSO₄⋅xH₂O dissolved in DI water. A 2 M sodium hydroxide solution is prepared by dissolving NaOH in DI water, and this hydroxide solution was used as the precipitator. An aqueous 0.5 M ammonium hydroxide solution is prepared in DI water and used to provide the coordinating ligand (ammonia). A batch reactor (600 mL) is filled with about 170 mL of DI water, and is stirred at 30° C. In the meantime, each reactant solution is fed into the reactor (a total of about 330 ml) and stirred overnight. The final solution pH typically is between 9 and 10 (e.g., 9.7). After that, the precipitate is isolated from the liquid medium by filtration. The precipitates are washed with DI water until the supernatant pH reads approximately 7. The precipitate is then vacuum filtered, and vacuum dried overnight to obtain the dried Ni_{0.5}Ti_{0.5} hydroxide co-precipitate precursor. The batch size is about 10 g/batch.

The coprecipitated precursor is then mixed with a decomposable carbon source, such as sucrose, and a suitable amount of lithium source, such as LiOH in a Li:TM mol ratio of at least about 1.2:1. This powder mixture is then placed in an electrically conductive reaction vessel and inductively heated at a high induction frequency), as described herein, to form carbon-coated particles of a lithium nickel titanium dioxide of approximate formula Li_{1.2}Mn_{0.40}Ti_{0.40}O₂. In some embodiments, the material can be prepared at three different induction frequencies (low, medium and high) to prepare a carbon-coated Li_{1.2}Mn_{0.40}Ti_{0.40}O₂ as described herein.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing materials or methods (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The terms “consisting of” and “consists of” are to be construed as closed terms, which limit any compositions or methods to the specified components or steps, respectively, that are listed in a given claim or portion of the specification. In addition, and because of its open nature, the term “comprising” broadly encompasses compositions and methods that “consist essentially of” or “consist of” specified components or steps, in addition to compositions and methods that include other components or steps beyond those listed in the given claim or portion of the specification. Recitation of ranges of values herein are merely intended to serve as a shorthand method of referring individually to each separate value falling within the range, unless otherwise indicated herein, and each separate value is incorporated into the specification as if it were individually recited herein. All numerical values obtained by measurement (e.g., weight, concentration, physical dimensions, removal rates, flow rates, and the like) are not to be construed as absolutely precise numbers, and should be considered to encompass values within the known limits of the measurement techniques commonly used in the art, regardless of whether or not the term “about” is explicitly stated. All methods described herein can be performed in any suitable order unless otherwise indicated herein or otherwise clearly contradicted by context. The use of any and all examples, or exemplary language (e.g., “such as”) provided herein, is intended merely to better illuminate certain aspects of the materials or methods described herein and does not pose a limitation on the scope of the claims unless otherwise stated. No language in the specification should be construed as indicating any non-claimed element as essential to the practice of the claims.

Preferred embodiments are described herein, including the best mode known to the inventors for carrying out the claimed invention. Variations of those preferred embodiments may become apparent to those of ordinary skill in the art upon reading the foregoing description. The inventors expect skilled artisans to employ such variations as appropriate, and the inventors intend for the claimed invention to be practiced otherwise than as specifically described herein. Accordingly, the claimed invention includes all modifications and equivalents of the subject matter recited in the claims appended hereto as permitted by applicable law. Moreover, any combination of the above-described elements in all possible variations thereof is encompassed by the claimed invention unless otherwise indicated herein or otherwise clearly contradicted by context.

The embodiments of the invention in which an exclusive property or privilege is claimed are defined as follows:

1. A process for preparing a carbon-coated electrode-active material comprising a predetermined ratio of alkali metal to non-alkali metals; the method comprising:
inductively heating a precursor mixture comprising a thermally decomposable carbon source, one or more metal-containing compound, and an alkali metal source, in a ratio of metal-containing compound-to-alkali metal source sufficient to provide the predetermined ratio of the alkali metal to non-alkali metals;
wherein the mixture is inductively heated at a frequency sufficient to bring the precursor mixture to a temperature sufficient to thereby form the carbon-coated electrode-active product; and wherein the alkali metal is Li or Na.

2. The process of claim 1, wherein the precursor material is inductively heated at one or more frequency selected from the group consisting of about 10 Hz to about 10 kHz, about 10 kHz to about 100 kHz, and about 100 kHz to about 1.2 MHz.

3. The process of claim 1, wherein the precursor mixture is inductively heated to a temperature of about 600 to about 850° C. to thereby form the carbon-coated electrode-active product.

4. The process of claim 1, wherein the electrode-active material is selected from the group consisting of a polyanion electrode-active material, a metal oxide electrode-active material, a conversion-type electrode-active material, and an anode electrode-active material.

5. The process of claim 1, wherein the decomposable carbon source is selected from the group consisting of a carbohydrate, a hydroxycarboxylic acid, biomass, an organic polymer, and a petroleum product.

6. The process of claim 1, wherein the carbon-coated electrode-active material is inductively heated at one or more additional induction frequency to refine the structure thereof; and/or wherein the initially formed electrode-active material or the carbon-coated electrode-active material is rapidly cooled after being formed, to stabilize the crystal structure thereof.

7. A process for preparing a carbon-coated alkali metal electrode-active material, the method comprising inductively heating a powdered mixture of a metal compound, an alkaline alkali metal source, and a thermally decomposable carbon source in a suitable reaction vessel under an inert atmosphere at one or more induction frequency within a range of about 10 Hz to about 1.2 MHz to raise the powdered mixture to a temperature of about 600 to about 850° C. and thereby form the carbon-coated alkali metal electrode-active material; wherein the alkali metal is Li or Na.

8. The process of claim 7, wherein the reaction vessel is an electrically conducting reaction vessel.

9. The process of claim 7, wherein the induction heating is achieved by inductively heating the reaction vessel containing the mixture of the metal compound, the alkali metal source, and the thermally decomposable carbon source within at least three induction heating coils under an inert atmosphere; wherein the reaction vessel is inductively heated within:
(a) a first induction heating coil operating at the first frequency,
(b) a second induction heating coil operating at the second frequency, and
(c) a third induction heating coil operating at the third frequency.

10. The process of claim 9, wherein the mixture is positioned within multiple electrically conductive reaction vessels situated on a moving conveyor belt that passes through the induction heating coils under an inert atmosphere, such that each container passes sequentially through each induction heating coil operating at a selected induction frequency, and the linear velocity at which the conveyor moves provides a residence time within the each induction coil sufficient to form the carbon-coated alkali metal compound electrode-active material.

11. The process of claim 7, wherein the decomposable carbon source is selected from the group consisting of a carbohydrate, a hydroxycarboxylic acid, biomass, an organic polymer, and a petroleum product.

12. The process of claim 7, wherein the metal compound is selected from the group consisting of a metal oxide, a metal hydroxide, a metal oxyhydroxide, a metal sulfide, a metal fluoride, a metal chloride, a metal phosphate, a metal pyrophosphate, a metal fluorophosphate, a metal sulfate, a metal fluorosulfate, a metal silicate, a metal carbonate, and a metal borate.

13. The process of claim 7, wherein the metal of the metal compound is selected from the group consisting of Al, Cr, Ga, Mg, Nb, Sn, La, Ta, Ti, W, Y, Zr, Mo, Fe, Mn, Ni, Co, and a combination of two or more thereof.

14. The process of claim 7, wherein the alkali metal compound electrode-active material is a material of a formula selected from the group consisting of AMO; AMOX, AMO₂, AMO₂X, AMS₂, AMS₂X, AMX₂, AMX₃ AMPO₄, AMP₂O₇, AMPO₄F, A₂M(SO₄)₂, AMSO₄F, A₂MSiO₄, and AMBO₃; wherein A is Li or Na; and M is at least one element selected from the group consisting of Al, Ca, Co, Cr, Fe, Ga, La, Mo, Mg, Mn, Nb, Ni, Sn, Ta, Ti, V, W, Y, and Zr; and X is at least one element selected from the group consisting of F and Cl.

15. The process of claim 14, wherein the alkali metal electrode-active material is doped with 0.1 to 20 mol % and/or is substituted with 20 to 90 mol % of one or more other element selected from the group consisting of Al, Ca, Co, Cr, Fe, Ga, La, Mo, Mg, Mn, Nb, Ni, Sn, Ta, Ti, V, W, Y, and Zr.

16. The process of claim 7, wherein the carbon-coated electrode-active material is inductively heated at one or more additional induction frequency to refine the structure thereof; and/or the initially formed alkali metal electrode-active material or the carbon-coated alkali metal electrode-active material is rapidly cooled after being formed, to stabilize the crystal structure thereof.

17. A process for preparing a carbon-coated alkali metal phosphate electrode-active material comprising: inductively heating a mixture of an iron phosphate compound, an alkali metal source, and a thermally decomposable carbon source in a conductive reaction vessel under an inert atmosphere at one or more induction frequency in the range of about 10 Hz to about 1.2 MHz to thereby heat the mixture to a temperature sufficient to form the carbon-coated alkali metal phosphate electrode-active material; wherein the alkali metal is Li or Na.

18. The process of claim 17, wherein the iron phosphate compound comprises at least one transition metal selected from the group consisting of Co, Cr, La, Mn, Mo, Nb, Ni, Sn, Ta, Ti, W, Y, and Zr, in addition to the iron.

19. The process of claim 17, wherein the iron phosphate compound is an iron manganese phosphate compound.

20. The process of claim 17, wherein the mixture is inductively heated to a temperature of about 600 to about 850° C. to thereby form the alkali metal iron phosphate electrode-active material.

21. The process of claim 17, wherein the alkali metal iron phosphate electrode-active material is doped with 0.1 to 20 mol % and/or is substituted with 20 to 90 mol % of one or more other element selected from the group consisting of Al, Ca, Co, Cr, Ga, La, Mo, Mg, Mn, Nb, Ni, Sn, Ta, Ti, V, W, Y, and Zr.

22. The process of claim 17, wherein the induction heating is achieved by inductively heating the reaction vessel containing the mixture of the iron phosphate compound, the alkali metal source, and the thermally decomposable carbon source within at least three induction heating coils under an inert atmosphere; wherein the reaction vessel is inductively heated within:
(a) a first induction heating coil operating at the first frequency;
(b) a second induction heating coil operating at the second frequency; and
(c) a third induction heating coil operating at the third frequency.

23. The process of claim 22, wherein the mixture is positioned within multiple electrically conducting reaction vessels situated on a moving conveyor belt that passes through the induction heating coils under an inert atmosphere, such that each container passes sequentially through each induction heating coil operating at a selected induction frequency, and the linear velocity at which the conveyor moves provides a residence time within each induction coil sufficient to form the carbon-coated alkali iron phosphate electrode-active material.

24. The process of claim 17, wherein the decomposable carbon source is selected from the group consisting of a carbohydrate, a hydroxycarboxylic acid, biomass, an organic polymer, and a petroleum product.

25. The process of claim 17, wherein the carbon-coated electrode-active material is inductively heated at one or more additional induction frequency to refine the structure thereof; and/or the initially formed alkali metal compound electrode-active material or the carbon-coated alkali metal compound electrode-active material is rapidly cooled after being formed, to stabilize the crystal structure thereof.
